(19) United States
(12) Patent Application Publication
(10) Pub. No.: US 2005/0011416 A1
(43) Pub. Date: Jan. 20, 2005

(54) Concrete thickener for thickening concrete article, said concrete article and process for producing same

(76) Inventor: Fritz Tollner, Marklohe (DE)

Correspondence Address: MERCHANT & GOULD PC, P.O. BOX 2903, MINNEAPOLIS, MN, 55402-0903, US

(21) Appl. No.: 10/642,891

(22) Filed: Aug. 18, 2003

(30) Foreign Application Priority Data
Jul. 14, 2003 (DE) 103 31 758.9

(51) Int. Cl. C04B 7/00; C04B 16/00; C04B 24/00; C04B 24/10; C04B 16/02; C04B 40/00

(52) U.S. Cl. 106/802; 106/805; 106/806; 106/808; 106/819; 106/823

(57) ABSTRACT

The present invention relates to a a concrete article, the concrete article, containing a concrete thickener, comprising the following components: a) about 20 to about 40% by weight, preferably about 30% by weight of a thickening agent; b) about 20 to about 40% by weight, preferably about 30% by weight of a hydrophobing additive; and c) remainder water; a process for producing a concrete article of the invention, and a concrete thickener for thickening concrete articles.

The present invention relates to a concrete thickener for thickening a concrete article, said concrete article and a process for producing a concrete article.

Concrete articles (paving stones, concrete ashlars) are nowadays mainly produced in two layers (coarse concrete and facing layer). As a rule, the facing layer has to satisfy particular requirements (e.g. coloration, mechanical strength, chemical resistance, exposure to the elements, resistance to frost and thawing salt and much more).

According to DIN 18 501, concrete paving stones must possess an average compression strength of 60 N/mm², and no single test result must be less than 50 N/mm². Concrete paving stones according to DIN 18 501 are generally regarded as resistant to attack by frost and thawing salt if they satisfy the requirements of the standard, it being necessary for the aggregates used to be sufficiently resistant to the effect of frost.

If concrete products exhibit white deposits on the surface, these are in most cases harmless lime precipitation. They are commonly referred to as bloom.

Lime bloom is a consequence of the material used in cement-bound products. The reason is that all standard cements contain a proportion of lime. Cement without lime is inconceivable, and there is no serviceable concrete in which the lime content is so low that lime precipitation would be impossible a priori. Whether and to what extent blooming occurs is also dependent on the weather, however.

Chemically, the deposits are calcium hydrate dissolved in water, which, after the water has evaporated and a reaction with the atmospheric carbon dioxide has taken place, appears on the surface of the concrete as calcium carbonate.

The quality of concrete paving and components is not impaired by this.

Bloom (lime precipitation) on concrete surfaces often occurs when the weather is cool and wet. Because of the delay in the curing process and the resultant better solubility of calcium hydroxide, the calcium hydrate which is released during the hydration process of the binder has an opportunity to migrate to the surface of the concrete through the capillary pore space of the concrete structure, dissolved in the mixing water. There, the calcium hydroxide reacts with the atmospheric CO₂, as a result of which poorly soluble calcium carbonate (CaCO₃) is formed, which precipitates on the surface of the concrete.

Bloom is frequently heavily promoted by other water (rain/condensation water) penetrating from the exterior. Depending on the closeness of the concrete structure and the speed of evaporation, calcium carbonate can occur visibly on the surface, but also invisibly within the structure, in the pore space. The intensity of the bloom depends in particular on the water/cement ratio, which is explained in more detail below.

Concrete is produced from cement, water and grains of stone. In order to influence certain properties of the concrete, it is also possible to add concrete additives. Green concrete, i.e. concrete which it is still possible to process, is given a desired shape, which it retains in the cured state, as artificial stone.

The grains of stone may comprise natural grains of stone, uncrushed or crushed, such as sand, gravel, crushed sand, stone chips and split gravel, and industrially produced grains of stone, such as blast furnace crushed sand and blast furnace slag gravel, and mixtures thereof.

The cement used for the concrete is a hydraulic binder. It is mixed with water and sets through hydration both in the air and under water. The hardened cement paste formed in this way is water-resistant. When water and cement are mixed, first of all cement paste is formed. This process takes place while the concrete is being mixed. The cement paste envelops the individual grains of stone, fills in the voids between them and makes it possible to process the green concrete. When the cement paste sets, hardened cement paste forms, which cements the grains of stone together. Many of the material properties of the solid hardened concrete depend on the properties of the hardened cement paste, especially the water/cement ratio (W/C ratio), i.e. the mass ratios of water to cement. The optimum W/C ratio, for example, influences the strength, the tendency to bloom, the resistance to frost and thawing salt, etc. of the hardened concrete.

A relatively small amount of water is needed to cure the concrete (complete hydration). In concrete technology, it is generally known that a W/C ratio of 0.40 can be regarded as the optimum in this respect. In this connection, it should be mentioned that the cement can only bind an amount of water equivalent to about 40% of its mass (about 25% chemically and 15% physically). A W/C ratio of 0.40 can also be disadvantageous, however, first of all because this then produces a consistency in the cement paste which makes the concrete mixture difficult to process; with this W/C ratio, production using a vibration-compaction method is not possible, for example, and secondly, the concrete articles produced from a concrete mixture of this kind do not retain their shape, they bulge, they are not stable and they stick to the parts of the mould.

In the vibration-compaction method, the concrete (base concrete or coarse concrete) is subjected to vibration while being placed in its appropriate mould by means of a charging car, and is briefly compacted. After that, the shell lime facing is applied to this concrete and the entire mixture is hydraulically compacted (mould pressure) and withdrawn (two-layer structure). In the case of single-layer production, only shell lime facing is used. The advantages of a vibration-compaction method consist in a rapid and homogeneous compaction, a low water/cement ratio and consequently concrete products with great strength, short cycle times and immediate release, a wide range of shaping possibilities, streamlined manufacture of the desired numbers and a fully automated production process.

One object of the present invention is to improve the generic concrete articles in such a way that the disadvantages of the state of the art are overcome, and especially that a concrete article is obtained in which higher W/C ratios can be adjusted, without necessarily changing the consistency of the concrete substantially in the process. A further object consists in providing a process for producing a concrete article containing a concrete thickener of the invention.

The first object is achieved by having the concrete article contain a concrete thickener comprising the following components:
a) about 20 to about 40% by weight, preferably about 30% by weight, of at least one thickening agent;
b) about 20 to about 40% by weight, preferably about 30% by weight, of at least one hydrophobing additive; and
c) remainder water.

The thickening agent is preferably an organic or inorganic polymer.

It can be provided here for the thickening agent to be selected from the group consisting of polyacrylates, polymethacrylates, polyurethanes, alginates, polyoses, cellulose derivatives, polycarboxylic acids, polyethers, polyimines, polyamides, silicic acid derivatives, zeolites and/or combinations thereof, polyacrylates, polyurethanes, cellulose derivatives and silicic acid derivatives being preferred.

It is advantageous for the concrete thickener to be present in the concrete article in a proportion of about 0.01 to about 2.0% by weight, preferably about 0.04 to about 1.0% by weight.

In addition, it is preferred for the hydrophobing additive to be selected from the group consisting of silanes, siloxanes, silicones, siliconates, fluorosilicates, hydrosilanes, fatty acids and their salts, waxes, acrylic resins, epoxy resins, polyurethanes, sodium silicates (alkali silicates), silicic acid esters and/or combinations thereof.

Furthermore, it is proposed that the concrete thickener should comprise dyes, water-soluble polymers, polymer dispersions, surface-active substances or mixtures thereof.

It can also be provided for the concrete article to contain further concrete admixtures, such as concrete additives and/or concrete addition agents.

In this context, it can preferably be provided for the concrete additives to be selected from the group consisting of concrete liquefiers, fluxes, air pore forming materials, sealing agents, retarders, accelerators, injection aids, stabilisers, chromate reducers, recycling aids for washing water and/or combinations thereof, and for the concrete addition agents to be selected from the group consisting of trass, powdered stone, coal flue dust, silica dust, pigments and/or combinations thereof.

In accordance with the invention, the concrete article is preferably characterised by a water/cement ratio of about 0.3 to about 0.5 preferably about 0.4.

It is advantageously provided for concrete articles to be produced in a vibration-compaction process.

A further object of the invention is achieved by a process for producing a concrete article, comprising the following steps:
i) mixing cement, grains of stone and make-up water, and optionally further concrete admixtures, such as concrete additives and/or concrete addition agents, in a mixer; and
ii) subsequently adding a concrete thickener to the mixture from step i), the concrete thickener comprising the following components:
a) about 20 to about 40% by weight, preferably about 30% by weight, of at least one thickening agent;
b) about 20 to about 40% by weight, preferably about 30% by weight, of at least one hydrophobing additive; and
c) remainder water.

In addition, it can be provided for the concrete thickener to be added into the mixer via an evacuation pump and a spray nozzle.

A concrete thickener, especially one for thickening a concrete article, is also proposed which comprises the following components:
a) about 20 to about 40% by weight, preferably about 30% by weight, of at least one thickening agent;
b) about 20 to about 40% by weight, preferably about 30% by weight, of at least one hydrophobing additive; and
c) remainder water.

The thickening agent in this case is preferably an organic or inorganic polymer.

Finally, it is particularly preferred on this connection that the thickening agent should be selected from the group consisting of polyacrylates, polymethacrylates, polyurethanes, alginates, polyoses, cellulose derivatives, polycarboxylic acids, polyethers, polyimines, polyamides, silicic acid derivatives, zeolites and/or combinations thereof.

The invention is based on the surprising finding that an additional amount of water can be added to a concrete article of the generic kind by adding a concrete thickener of the invention, and the setting behaviour of the concrete is improved substantially, without the resulting consistency of the concrete limiting the processability of the concrete or its use in certain manufacturing processes. The concrete articles of the invention retain their shape, do not bulge, are stable and do not stick to the parts of the mould, so that they in particular make it possible to release the concrete article while it is still fresh.

In the case of concrete articles of the invention, the large amount of water present in the concrete mixture when the water/cement ratio is high, such as at a W/C ratio of about 0.40, is first of all stored by the concrete thickener and gradually released in order to hydrate the cement. However, only just as much water is released in the process as is needed for hydration; a surplus of water, with the disadvantages which that involves, is avoided.

A further important property of the concrete thickener of the invention is that it is rendered hydrophobic thanks to the presence of a hydrophobing additive. This hydrophobing additive ensures that water from outside the concrete mixture is repelled and that there is no negative influence on the hydration process for setting the concrete, namely as a result of any possible shift in the hydration balance.

When the concrete thickener of the invention is added to a concrete article of the invention, the tendency of the resultant hardened concrete to bloom is reduced considerably. In addition, the strength of the concrete is increased, because it is possible to add additional water. Furthermore the concrete article of the invention exhibits an excellent readiness to be compacted without any tendency to stick, and a high green bond. Finally, the water penetration capacity is reduced, and a high level of resistance to frost and thawing salt is achieved.

In the process of the invention, it should be pointed out that the direct addition of the concrete thickener directly onto the grains of stone, as is generally conventional in the field of additives, is not possible here. An optimum effect of the concrete thickener is preferably achieved by adding it to the otherwise finished mixture for the concrete article. It is preferably added with a proportioning weigher (type BPB, Beton- und Prüftechnik Blomberg GmbH & Co. KG, 32825 Blomberg) via an evacuation pump and a spray nozzle into a mixer containing the concrete mixture. The holding time for mixing with the concrete thickener can be about 30 seconds. During this time, the concrete mixture, which is actually too moist, is converted to a consistency level that can be processed in the KS process, i.e. a stiff, “slightly moist” consistency with a low water/cement ratio.

Further features and advantages of the present invention will become apparent from the following detailed description and the example given there of the production of a concrete article of the invention.

A typical formulation for a concrete article of the invention is as follows:
cement: 380 kg/m³
sand (diameter of the grains of sand ≦2 mm): 1,320 kg/m³
gravel (diameter of the particles of gravel 1-3 mm): 510 kg/m³
make-up water: 151 kg/m³
W/C ratio: 0.40
concrete thickener: 1.14-1.90 kg/m³

The concrete thickener here is in the form of a composition comprising about 30% by weight thickening agent, about 30% by weight hydrophobing additive and the remainder water.

In order to produce the concrete article of the invention, the above-mentioned components, with the exception of the concrete thickener, are first of all blended in a mixer. After mixing appropriately, the concrete thickener is added, preferably via a spray nozzle, and a processable consistency is achieved through further mixing.

When the formulation specified above is used, a concrete article is finally obtained which exhibits the advantages and properties mentioned in the description.

The features of the invention disclosed in the above description and in the claims can be essential to implementing the invention in its various embodiments both individually and in any combination

1. Concrete article, wherein the fact that the concrete article contains a concrete thickener comprising the following components:
a) about 20 to about 40% by weight, preferably about 30% by weight, of at least one thickening agent;
b) about 20 to about 40% by weight, preferably about 30% by weight, of at least one hydrophobing additive; and
c) remainder water.

2. The concrete article as claimed in claim 1, wherein the fact that the thickening agent is an organic or inorganic polymer.

3. The concrete article as claimed in claim 2, wherein the fact that the thickening agent is selected from the group consisting of polyacrylates, polymethacrylates, polyurethanes, alginates, polyoses, cellulose derivatives, polycarboxylic acids, polyethers, polyimines, polyamides, silicic acid derivatives, zeolites and/or combinations thereof, polyacrylates, polyurethanes, cellulose derivatives and silicic acid derivatives being preferred.

4. The concrete article as claimed in claim 1, by wherein the fact that the concrete thickener is present in the concrete article in proportion of about 0.01 to 2.0% by weight, preferably about 0.04 to about 1.0% by weight.

5. The concrete article as claimed in claim 1, wherein the fact that the hydrophobing additive is selected from the group consisting of silanes, siloxanes, silicones, siliconates, fluorsilicates, hydrosilanes, fatty acids and their salts, waxes, acrylic resins, epoxy resins, polyurethane resins, sodium silicates (alkali silicates), silicic acid esters and/or combinations thereof.

6. The concrete article as claimed in claim 1, wherein the fact that the concrete thickener further comprises dyes, water-soluble polymer, polymer dispersions, surface-active substances of mixtures thereof.

7. The concrete article as claimed in claim 1, wherein the fact that the concrete article contains further concrete admixtures, such as concrete additives and/or concrete addition agents.

8. The concrete article as claimed in claim 7, wherein the fact that the concrete additives are selected from the group consisting of concrete liquefiers, fluxes, air pore forming materials, sealing agents, retarders, accelerators, injection aids, stabilizers, chromate reducers, recycling aids for washing water and/or combinations thereof, and the concrete addition agents are selected from the group consisting of trass, powdered stone, coal flue dust, silica dust, pigments and/or combinations thereof.

9. The concrete article as claimed in claim 1, wherein a water/cement ratio of about 0.3 to about 0.5 preferably about 0.4.

10. The concrete article as claimed in claim 1, produced in a vibration-compaction process.

11. A process for producing a concrete article, especially as claimed in claim 1, comprising the following steps:
i) mixing cement, grains of stone and make-up water, and optionally further concrete admixtures, such as concrete additives and/or concrete addition agents, in a mixer; and
ii) subsequently adding a concrete thickener to the mixture from step i), the concrete thickener comprising the following components:
a) about 20 to about 40% by weight, preferably about 30% by weight, of at least one thickening agent;
b) about 20 to about 40% by weight, preferably about 30% by weight, of at least one hydrophobnig additive; and
c) remainder water.

12. The process as claimed in claim 11, wherein the fact that the concrete thickener is added into the mixer via an evacuation pump and a spray nozzle.

13. A concrete thickener, especially one for thickening a concrete article, which comprises the following components:
a) about 20 to about 40% by weight, preferably about 30% by weight, of at least one thickening agent;
b) about 20 to about 40% by weight, preferably about 30% by weight, of at least one hydrophobing additive; and
c) remainder water

14. The concrete thickener as claimed in claim 13, wherein the fact that the thickening agent is an organic or inorganic polymer.

15. The concrete thickener as claimed in claim 14, wherein the fact that the thickening agent is selected from the group consisting of polyacrylates, polymethacrylates, polyurethanes, alginates, polyoses, cellulose derivatives, polycarboxylic acids, polyethers, polyimines, polyamides, silicic acid derivatives, zeolites and/or combinations thereof.
